(19) United States
(12) Patent Application Publication
(10) Pub. No.: US 2010/0250533 A1
(43) Pub. Date: Sep. 30, 2010

(54) Generating Recommendations for Content Servers

(75) Inventors: Roberto AGRO, Montrouge (FR); Vincent Murphy, La Madeleine (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/727,424

(22) Filed: Mar. 19, 2010

(30) Foreign Application Priority Data
Mar. 19, 2009 (FR) 0951749

(51) Int. Cl. G06F 17/30; G06F 15/16

(52) U.S. Cl. 707/736; 707/E17.044; 709/219

(57) ABSTRACT

A multimedia content server including a memory area in which metadata is stored in association with at least one content accessible via said server and usable for selecting at least one of said contents with a view to formulating a request for access to the selected content, said server including:
storage means adapted to store in a data structure all or part of the metadata stored in said memory area;
means for sending said data structure to a recommendation engine adapted to obtain on the basis of the metadata contained in said data structure content recommendations in the form of second metadata for at least one content accessible via said server;
means for enriching the metadata stored in said memory area with said content recommendations.

### BACKGROUND OF THE INVENTION

The present invention relates to the field of telecommunications networks, for example networks in which terminals communicate with one another using the UPnP protocol defined by the UPnP Forum and the DLNA Consortium. The network may be a home network, for example, or a local area network (LAN).

As is known in the art, the UPnP protocol aims to allow interoperability and interconnection of multimedia equipments without requiring the user to perform any configuration process.

In the description below, the expression “UPnP network” refers to a set of equipments that are interconnected to form a network and that use the UPnP protocol to communicate with one another via the network.

A device is referred to as a “UPnP device” if it is able to communicate by means of a control protocol conforming to the UPnP standard or another equivalent or derived standard and/or uses one or more of the functions defined in such a standard.

Different types of UPnP device are generally distinguished in UPnP architectures: DMC (Digital Media Controller) control devices; DMS (Digital Media Server) content servers; and content rendering devices DMR (Digital Media Renderer), DMA (Digital Media Adapter) and DMP (Digital Media Player).

In a UPnP network, the DMC control device has a central role in that it is used to discover other UPnP devices in the network and the services offered by those devices and to connect a DMS server with a DMR or DMA rendering device in order for that rendering device to render a multimedia content indexed by that DMS server.

Historically, the multimedia contents manipulated in UPnP networks have been local to the home network.

Nowadays, some DMS content servers can also index contents accessible on line, for example on the Internet network, and make them locally available on the UPnP network.

The invention proposes a mechanism for automatically enriching the list of indexed contents in a content server, which mechanism is applicable to a UPnP-type content server, especially to a content server that can index contents accessible on line.

### OBJECT AND SUMMARY OF THE INVENTION

A first aspect of the invention provides a multimedia content server including a memory area in which first metadata is stored in association with at least one content accessible via said server and usable for selecting at least one of said contents with a view to formulating a request for access to the selected content, the server including:
storage means adapted to store in a data structure all or part of the first metadata stored in said memory area;
means for sending said data structure to a recommendation engine adapted to obtain on the basis of the first metadata contained in said data structure content recommendations in the form of second metadata for at least one other content accessible via said server;
means for obtaining said content recommendations; and
means for enriching the first metadata stored in said memory area with said content recommendations.

In a correlated way, the invention provides a method of updating a memory area of a multimedia content server, said memory area including first metadata associated with at least one content accessible via said server and usable for selecting at least one of said contents with a view to formulating a request for access to the selected content, said method being executed by said server and including:
a step of storing in a data structure all or part of the first metadata stored in said memory area;
a step of sending said data structure to a recommendation engine adapted to obtain on the basis of the first metadata contained in said data structure content recommendations in the form of second metadata for at least one other content accessible via said server;
a step of obtaining said content recommendations; and
a step of enriching the first metadata stored in said memory area with said content recommendations.

Thus the invention is capable of automatically enriching the list of metadata for multimedia contents from a content server, which metadata is available, in a UPnP content server, via a DMC control device of the network for selecting at least one content on the basis of that metadata and rendering the selected content or contents.

Contents accessible via the content server include both contents accessible directly from said content server, i.e. physically stored in that server, on a medium specific to that server, and contents accessible via the content server but physically stored on a remote server, especially an on-line content server. All these contents can therefore be the subject of an access request to said server, whether for rendering or simply for downloading.

In one embodiment of the invention, contents for which metadata is stored in said data structure are contents that have been the subject of a request for access via said server, for example with a view to rendering by DMR, DMA or DMP rendering devices of the network. Thus no modification is required to the DMR, DMA, DMP rendering devices or the DMC control device.

The multimedia contents themselves are physically stored on the server or on another machine, for example on a web server accessible via a connection set up via the Internet network.

When the multimedia contents are stored on a remote server, the content server of the invention acts as a proxy. In this particular embodiment of the invention, the server includes access means for obtaining the multimedia content from the remote server and relaying the multimedia content to one or more rendering devices, especially to a UPnP rendering device of the local area network to which the content server belongs. Thus rendering by a UPnP rendering device is effected in exactly the same way whether the content to be rendered is stored locally on the content server of the local area network or remotely on a remote server. The result of this is to enrich the catalogue of contents that can be rendered by a UPnP rendering device of a local area network.

Furthermore, the content server includes means for relaying a request for access to a content coming from a rendering device to a remote content server, the storage means of said server being designed also to store in said data structure metadata associated with the contents that have been the subject of a content rendering request relayed via said server.

The metadata may contain different types of information. For a music album, for example, it can contain the name of the album, the names of the tracks, the name of the artist, and a pointer to the musical content itself.

The recommendation engine is designed to generate content recommendations in the form of metadata associated with the recommended contents as a function of the content metadata received in the data structure.

For example, when the data structure includes a film title, the recommendation engine may select metadata of other films by the same director, the original soundtrack album of the film, the biography of one of the actors, etc.

It should be noted that the method of generating recommendations as such is not part of the invention. This mechanism may be implemented by a recommendation engine of a type known in the art, for example the MEDIA UNBOUND engine (www.mediaunbound.com).

In one particular embodiment of the invention, the data structure includes, associated with the metadata for at least one multimedia content, information representing the fact that said server has already sent at least part of the multimedia content to at least one DMA, DMR, DMP rendering device of the network.

This information constitutes a measurement (or weighting) of the interest of the network users in a particular multimedia content. It may therefore be used as such by the recommendation engine, to produce recommendations in the form of metadata.

Accordingly, by means of the invention, an operator may propose to the users of a network, for example a home network, contents likely to be of great interest to them, in a totally automatic and non-intrusive way.

The invention further provides a platform adapted to communicate with at least one multimedia content server of the invention and comprising:
means for receiving from said server a data structure containing metadata associated with at least one of said multimedia contents;
means for sending said data structure to a recommendation engine adapted to obtain from the metadata contained in said data structure content recommendations in the form of metadata for at least one content accessible via said server;
means for obtaining said content recommendations; and
means for sending said server said content recommendations.

Such a platform acts as an intermediary between one or more content servers and a recommendation engine. For example, this reduces the cost of implementing metadata translation functions when the presentation format of metadata supplied by a content server is different from the presentation format of metadata generated by the recommendation engine.

In one embodiment, this platform includes:
means for receiving an identifier specific to said server with said data structure; and
means for supplying in response to a request containing said identifier content recommendations generated on the basis of at least one data structure sent with that identifier.

Thus the platform can cooperate with different servers at the same time as allowing generation of recommendations specific to only one of the servers.

The invention also provides a system including a server of the invention and a platform of the invention.

In the server of one embodiment of the invention, the storage means are designed to store in said data structure only metadata associated with a predefined subset of all the contents accessible via said server. This feature may be used to generate recommendations for different purposes.

For example, when the predefined subset of contents consists of contents that have been the subject of a request for access via said server, recommendations could be generated for contents having some relationship (same author, same musical genre, etc.) with contents that have been the subject of an access request, i.e. contents that are a priori of interest to the user.

Another example of a predefined subset is a subset defined by a user. Such recommendations could be generated for contents belonging to a given musical genre, a given author, a given time period, etc., depending on the subset defined by the user, for example by selecting a subset of contents on the basis of metadata stored by the content server. The server then stores in the data structure the metadata for the contents forming this subset and generates recommendations according to themes defined by the user.

The server of one particular embodiment of the invention includes (in other words incorporates) the recommendation engine.

Alternatively, the recommendation engine may be shared by a plurality of servers of the invention, or even by other equipments.

The server of one particular embodiment of the invention includes:
means for sending an identifier specific to said server with said data structure to an entity adapted to send said data structure to said recommendation engine and to obtain content recommendations on the basis of said data structure; and
means for interrogating said entity using said identifier in order to obtain content recommendations generated on the basis of at least one data structure sent with that identifier.

Thus the server can obtain recommendations that are specific to it. When the server includes software used by one or more users, the recommendations produced are specific to that user or those users.

The above-mentioned entity may be the recommendation engine itself, a server incorporating the recommendation engine or an intermediary platform between the server and the recommendation engine.

In one particular embodiment of the invention the memory area in which the server stores the metadata includes at least one sub-area reserved for at least part of said recommended metadata.

In one particular embodiment of the invention, the memory area is organized in the form of a tree, each sub-area being a sub-tree of that tree.

For example, an area sub-tree can be reserved for a type of content (image, music, video, etc.).

In this particular embodiment of the invention the user can easily and quickly identify the recommended metadata in the tree of the DMS content server.

The recommended metadata may be obtained by the server of the invention in various ways, for example when the server is started up and then periodically.

In one particular embodiment of the invention, the steps of the updating method of the invention are determined by computer program instructions.

Consequently, the invention also provides a computer program on an information medium and including instructions adapted to execute the steps of the updating method of the invention executed by the content server.

This program may use any programming language and take the form of source code, object code or a code intermediate between source code and object code, such as a partially compiled form, or any other desirable form.

The invention also provides a computer-readable information medium containing instructions of a computer program as referred to above.

The information medium may be any entity or device capable of storing the program. For example, the medium may include storage means, such as a ROM, for example a CD ROM or a micro-electronic circuit ROM, or magnetic storage means, for example a floppy disk or a hard disk.

Moreover, the information medium may be a transmissible medium such as an electrical or optical signal, capable of being routed via an electrical or optical cable, by radio or by other means. The program of the invention may in particular be downloaded over an Internet-type network.

Alternatively, the information medium can be an integrated circuit incorporating the program, the circuit being adapted to execute the method in question or to be used in its execution.

### BRIEF DESCRIPTION OF THE DRAWINGS

Other features and advantages of the present invention emerge from the description given below with reference to the appended drawings, which show one non-limiting embodiment of the invention. In the figures:

FIG. 1 represents a UPnP server of one particular embodiment of the invention;

FIG. 2 represents one example of a multimedia content tree suitable for use in the invention; and

FIG. 3 represents diagrammatically the main steps of an updating method of one particular embodiment of the invention.

### DETAILED DESCRIPTION OF ONE EMBODIMENT

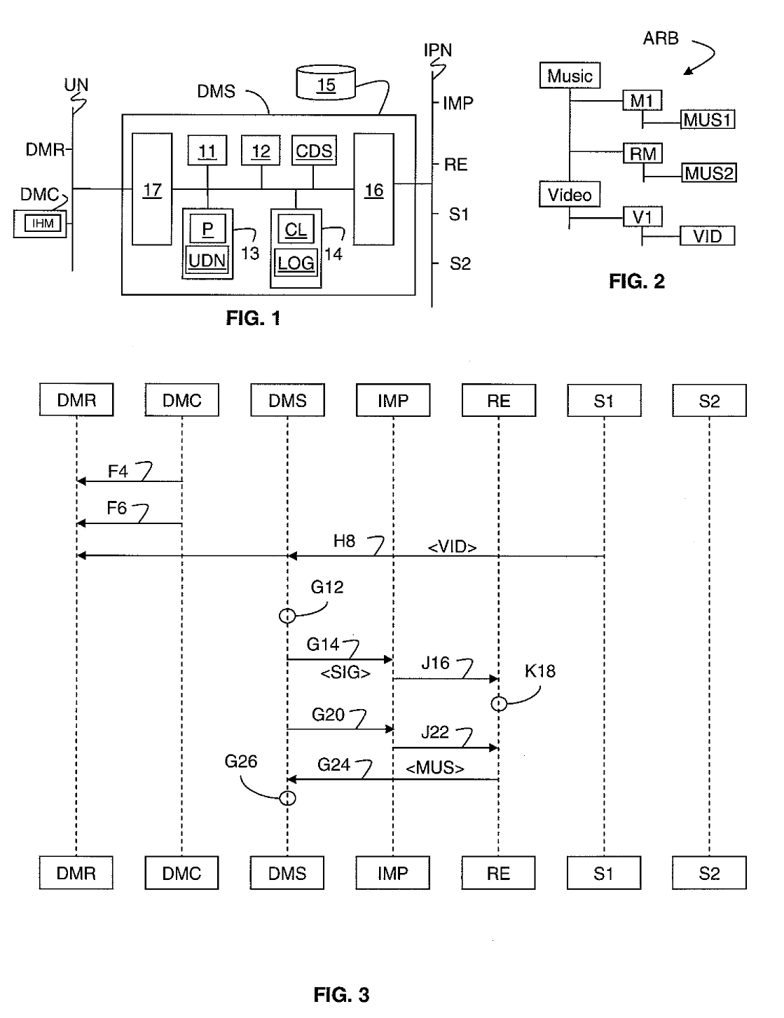

FIG. 1 represents a UPnP server DMS of the invention.

This server DMS uses the functions defined by the UPnP standard for a content server of the Digital Media Server (DMS) type.

In the embodiment of the invention described here, the server DMS has the hardware architecture of a computer. It thus includes a processor 11, a random-access memory 12, a read-only memory (ROM) 13, a non-volatile rewritable Flash memory 14, and an external memory 15.

In the embodiment of the invention described here, the read-only memory 13 of the UPnP server DMS includes a UDN (Unique Device Name) identifier that uniquely identifies the server DMS in the manner defined by the UPnP standard.

The server DMS further includes a communications interface 17 suitable for communicating with UPnP devices of a UPnP network UN, especially DMR and DMC devices.

The UPnP content server DMS includes a communications interface 16 suitable for communicating with other equipments via the Internet network IPN, especially with remote content servers S1 and S2.

FIG. 1 shows four equipments connected to the Internet network IPN and able to communicate with the UPnP server DMS, namely an intermediary platform IMP, a recommendation engine RE, and two remote content servers S1 and S2.

For managing a memory area CL containing metadata associated with multimedia contents the content server DMS implements the Content Directory Service (CDS) defined by the UPnP standard.

These multimedia contents are commonly referred to as being indexed in the memory area CL. The multimedia contents indexed in the memory area CL can be stored on the UPnP server DMS or on remote content servers of the same type as the servers S1 and S2.

In the embodiment of the invention described here, the memory area CL is part of the non-volatile rewritable memory 14 and is organized in the form of a tree ARB, as shown in FIG. 2.

In the example described here, this tree ARB includes two main directories “Music” and “Video” for indexing metadata of music files and video files, respectively.

The “Music” directory includes two sub-directories “M1” and “RM”.

The directory “RM” is a sub-tree reserved for indexing metadata associated with music files that are recommended in the sense of the invention. In the FIG. 2 example, this directory “RM” includes metadata MUS2 for a music file (for example an MP3 file) recommended to users of the UPnP network UN.

In the embodiment of the invention described here:
metadata for a music file “MUS1” is stored in the sub-directory “M1”; and
the “Video” directory includes a sub-directory “V1” in which metadata “VID” for a video file is stored.

The metadata stored in the tree ARB is used to select a content that is accessible via the server DMS, especially if a request for rendering of one of those contents is sent from a UPnP rendering device DMR connected to the server DMS.

As defined by the UPnP protocol, the metadata stored in the tree ARB and managed by the server DMS is accessible on demand by a control device DMC with a view to selection of the content to be rendered by a rendering device DMR.

According to the invention, the server DMS includes a software module referred to as a storage module for storing a data structure LOG in which it can store metadata contained in the tree ARB.

The contents for which metadata is stored in the data structure LOG are accessible via the server DMS, i.e. accessible directly in the server DMS and/or accessible in the remote servers S1 or S2 via the server DMS acting as a proxy on behalf of the remote servers S1 or S2.

In a first embodiment of the invention, the storage module is designed to store in the data structure LOG metadata associated with all contents accessible via the server DMS.

In a second embodiment of the invention, the storage module is designed to store in the data structure LOG only metadata associated with a predefined subset of contents accessible via the server DMS.

In a first variant of this second embodiment of the invention, this subset consists of contents that have been the subject of an access request to the server DMS. In this first variant, storage is effected on each content access request processed by the server DMS, for example a request to transfer a content or a request to render a content processed by the server DMS.

Consequently, the metadata stored in the data structure LOG relates to contents that have been the subject of a rendering request or more generally an access request.

In a second variant of this second embodiment of the invention, this subset consists only of contents that are accessible directly in the server DMS, excluding contents that are accessible in one of the remote servers S1 or S2.

In a third variant of this second embodiment of the invention, this subset of contents is defined according to a selection effected by a user and/or criteria defined by the user: it is thus possible for a user to obtain recommendations for only a given musical genre (classical music, French popular music, jazz, etc.) or video genre (comedy, documentary, science fiction, etc.).

The variants mentioned above for the definition of the subset can be combined with one another. A parameter-setting interface of the server DMS is provided to facilitate defining the subset to be considered when generating the data structure LOG.

The storage module is furthermore designed to store in the data structure LOG, in association with metadata associated with a content, information representing the fact that the server DMS has already sent at least part of that multimedia content to at least one rendering device or to another device that has sent a request to access that content.

This information can be a percentage, for example, “0%” signifying “content not rendered”, “100%” signifying “all of content rendered”, “x %” signifying “x % of content rendered”.

This information can thus include the number of times that a multimedia content has been accessed.

Be this as it may, this information constitutes a measurement (or weighting) of the interest of UPnP network users in a particular multimedia content. It can thus be used as such by the recommendation engine to choose recommended metadata. This information is particularly beneficial to use in the first embodiment of the invention described above because it allows automatic preselection by the recommendation engine of contents of interest to users from all accessible contents for which it has received metadata.

In the embodiment described here, the data structure LOG is stored in the non-volatile rewritable Flash memory 14.

It is assumed in the remainder of the description that the UPnP server DMS stores in the data structure LOG, in association with the metadata for a multimedia content, a percentage rendering (0% to 100%) of that multimedia content.

According to the invention, the UPnP server DMS sends this data structure LOG to the recommendation engine RE. In the embodiment of the invention described here, the UPnP server DMS sends the data structure LOG to the intermediary platform IMP, which relays it to the recommendation engine.

The recommendation engine RE analyzes the data structure received to produce content recommendations based on the metadata contained in that structure. These recommendations are produced in the form of metadata associated with contents accessible via the server DMS, especially contents accessible on line in a remote server S1 or S2. These recommendations can thus be stored in the tree ARB managed by the server DMS in the same way as the other metadata of that tree.

The presentation format of the metadata forming content recommendations generated by the recommendation engine RE is optionally different from the presentation format of the metadata present in the data structure LOG. Format adaptation is effected in this situation, preferably by the intermediary platform, or even by the server DMS or the recommendation engine. This adaptation is effected firstly on the metadata contained in the data structure LOG to generate metadata suitable for processing by the recommendation server and secondly on the metadata generated by the recommendation engine RE to generate metadata suitable for storage in the tree ARB.

In the remainder of the description it is assumed that the recommendation engine RE:
ignores any metadata associated with a multimedia content of which less than 20% has been rendered; and
inserts into the content recommendations the metadata associated with the original soundtrack album of the films rendered on the UPnP network.

The read-only memory (ROM) 13 includes a computer program P of the invention for executing the method of updating the memory area CL, the main steps G12 to G26 of which are described below with reference to FIG. 3.

It is assumed in this example that before the method of the invention is executed the tree ARB contains:
main directories “Music” and “Video”;
sub-directories “M1” and “V1”;
metadata “MUS1” in sub-directory M1;
metadata “VID” in sub-directory V1;
sub-directory “RM” (and a fortiori its content “MUS2”), not yet created in the tree ARB.

In the embodiment described here, it is assumed that the user is using a man-machine interface IHM of the UPnP control device DMC to view the content of the tree ARB and to select the metadata “MUS1” for the music file and to designate the rendering device DMR for listening to that music.

In a manner that is known in itself, the control device DMC sends the URL of this music file to the rendering device DMR during a step F4 using the UPnP action “SetAVTransportURI”.

The control device DMC then sends the rendering device DMR a Play instruction during a step F6 in order for said device to open a connection to the server DMS.

It is assumed in this example that the music file selected is hosted by the remote server S1 of the Internet network IPN. That file is then sent to the rendering device DMR via the server DMS during a step H8. In this mechanism, the server DMS can be described as a proxy in that it serves as an intermediary between the remote content server S1 and the rendering device DMR, both for sending the server S1 requests for access to a content coming from the rendering device DMR and for sending the rendering device DMR contents supplied by the server S1.

It is assumed that the user interrupts downloading after 20% of this content has been downloaded by the rendering device DMR.

In the embodiment of the invention described here, the UPnP server DMS systematically stores in the data structure LOG during a step G12 the metadata for the contents indexed in the tree ARB and accessed by the devices of the UPnP network, together with the percentage rendering. The metadata MUS1 of the music file accessed by the rendering device DMR and the information “20%” are thus stored in this data structure LOG.

It is assumed that another UPnP network user downloads the whole of the video file associated with the metadata VID.

Thus the metadata VID and the information “100%” are stored in this data structure LOG during the same step G12.

According to the invention, during a step G14 the UPnP server DMS sends the intermediary platform IMP a signal SIG conveying the data structure LOG and an identifier specific to the content server DMS.

In one particular embodiment of the invention, this identifier consists of a UDN (Unique Device Name) identifier of the server DMS, i.e. of the program implementing that server. Thus it can in particular consist of a license key specific to the UPnP server.

In the embodiment of the invention described here, data structures are sent periodically. Alternatively, they can be sent at the command of a user of the network UN.

In the embodiment of the invention described here, the intermediary platform IMP sends the signal SIG to the recommendation engine RE during a step J16.

Alternatively, the recommendation engine RE can be integrated into the intermediary platform IMP.

In the embodiment of the invention described here, the recommendation engine RE therefore receives:
metadata MUS1 associated with the information “20%”;
metadata VID associated with the information “100%”.

During a step K18, the recommendation engine RE identifies contents liable to be of interest to users of the UPnP network UN on the basis of the data structure LOG.

According to the assumption referred to above, the recommendation engine RE ignores the metadata MUS1 and selects a music file (with metadata MUS2) including the original soundtrack of the video with metadata VID.

In the embodiment of the invention described here, the UPnP server DMS regularly sends the intermediary platform IMP requests to obtain content recommendations (step G20).

In the embodiment of the invention described here, the intermediary platform IMP sends this request to the recommendation engine RE during a step J22.

According to the invention, the UPnP server DMS sends a request containing an identifier specific to the server DMS to obtain recommendations generated on the basis of data structures LOG sent with that identifier. The server DMS then receives during a step G24 recommendations generated by the recommendation engine in the form of metadata MUS2 for the data structure or structures LOG sent with that identifier. The recommendations produced in return are produced specifically for users of this server DMS, in particular in accordance with the parameters of that server as set by its users.

In the embodiment of the invention described here, it is assumed that the music file associated with the metadata MUS2 is hosted on a server S2 on the Internet network IPN.

According to the invention, during the step G26 the UPnP server DMS indexes the metadata MUS2 in the tree ARB, i.e. enriches the metadata of the tree ARB with the metadata MUS2, in order to make the recommended contents—associated with the metadata MUS2—selectable from the tree ARB.

In the embodiment of the invention described here, this metadata MUS2 is stored in the reserved directory RM of the main directory “Music” of the tree ARB.

This new content is part of the content accessible via the server DMS and can be selected on demand by all users of the UPnP network UN by consulting the reserved directory RM. This new content can thus be rendered by a UPnP rendering device in the same way as contents stored locally by the server DMS that are indexed from the outset in the directory CDS.

The invention is implemented by means of the UPnP protocol or any other protocol usable for accessing a content server and sending content access and/or content rendering requests. The invention and its principles are thus applicable to any type of content server, any type of rendering device, and any type of recommendation engine.

What is claimed is:

1. A multimedia content server including a memory area in which first metadata is stored in association with at least one content accessible via said server and usable for selecting at least one of said contents with a view to formulating a request for access to the selected content, wherein said server includes:
storage means adapted to store in a data structure all or part of said first metadata stored in said memory area;
means for sending said data structure to a recommendation engine adapted to obtain on the basis of the first metadata contained in said data structure content recommendations in the form of second metadata for at least one other content accessible via said server;
means for obtaining said content recommendations; and
means for enriching the first metadata stored in said memory area with said content recommendations.

2. A server according to claim 1, wherein the storage means are designed to store in said structure only first metadata associated with a predefined subset of all contents accessible via said server.

3. A server according to claim 2, wherein the predefined subset of contents consists of contents that have been the subject of a request for access via said server.

4. A server according to claim 2, wherein the predefined subset is a subset defined by the user.

5. A server according to claim 1, wherein said storage means are designed to store in said data structure in association with the first metadata of at least one multimedia content information representing the fact that the server has already sent at least part of said multimedia content to at least one content rendering device.

6. A server according to claim 1, including:
means for sending an identifier specific to said server with said data structure to an entity adapted to send said data structure to said recommendation engine and to obtain content recommendations on the basis of said data structure; and
means for interrogating said entity using said identifier in order to obtain content recommendations generated on the basis of at least one data structure sent with that identifier.

7. A server according to claim 1, wherein said memory area includes at least one sub-area reserved for at least part of the metadata forming content recommendations.

8. A server according to claim 1, wherein when said other content is stored on a remote server said access means are adapted to obtain said other content from the remote server and to relay the content obtained to one or more rendering devices.

9. A server according to claim 1, including means for relaying a request for access to a content coming from a rendering device to a remote content server, the storage means being designed also to store in said data structure metadata associated with the contents that have been the subject of a content rendering request relayed via said server.

10. A method of updating a memory area of a multimedia content server, said memory area including first metadata associated with at least one content accessible via said server and usable for selecting at least one of said contents with a view to formulating a request for access to the selected content, said method being executed by said server and includes:
a step of storing in a data structure all or part of the first metadata stored in said memory area;
a step of sending said data structure to a recommendation engine adapted to obtain on the basis of the first metadata contained in said data structure content recommendations in the form of second metadata for at least one other content accessible via said server;
a step of obtaining said content recommendations; and
a step of enriching the first metadata stored in said memory area with said content recommendations.

11. A computer program including instructions for executing the steps of the updating method according to claim 10 when said program is executed by a computer.

12. A storage medium readable by a computer and storing a computer program comprising instructions for executing the steps of the updating method according to claim 10.

13. A platform adapted to communicate with at least one multimedia content server according to claim 1 and comprising:
means for receiving from said server a data structure containing metadata associated with at least one of said multimedia contents;
means for sending said data structure to a recommendation engine adapted to obtain from the metadata contained in said data structure content recommendations in the form of metadata for at least one content accessible via said server;
means for obtaining said content recommendations; and
means for sending said server said content recommendations.

14. A platform according to claim 13 comprising:
means for receiving an identifier specific to said server with said data structure; and
means for supplying in response to a request containing said identifier content recommendations generated on the basis of at least one data structure sent with that identifier.
